(19) United States
(12) Patent Application Publication
(10) Pub. No.: US 2014/0058740 A1
(43) Pub. Date: Feb. 27, 2014

(54) METHOD AND SYSTEM FOR PRE-OPERATIVE DOCUMENT MANAGEMENT

(71) Applicant: Andrew Barnett, Belvedere, CA (US)

(72) Inventor: Andrew Barnett, Belvedere, CA (US)

(21) Appl. No.: 13/594,168

(22) Filed: Aug. 24, 2012

(51) Int. Cl. G06Q 50/22

(52) U.S. Cl. 705/2

(57) ABSTRACT

An electronic method and system for managing scheduling of surgical procedures and corresponding pre-operative documentation. A rescheduling request is sent from a first client computer to a server to reschedule a medical procedure. The server forwards the rescheduling request to a second client computer, where the request is approved or rejected. If approved, a list of documents required for the procedure is generated and posted on the server. The required documents are then uploaded to the server. The required documents are reviewed and approved or rejected based on criteria associated with each document.

### BACKGROUND

This disclosure relates generally to the field of medical document management, and more specifically, to systems and methods for managing the collection, validation and approval of documents required for pre-operative review, and for electronic transfer of these documents between different entities in the pre-operative process.

Accepted standards of medical care establish clinical guidelines for pre-surgery testing. Best practices require that results of that testing be available to all involved health practitioners at the time of surgery. Missing or incomplete information may delay surgery start time, resulting in cancellation of surgery, and present health risks to patients.

Documentation of laboratory results (e.g. blood tests, electro-cardiograms, chest x-rays) and general health status (e.g. history and physical examinations) is required prior to beginning many medical procedures (e.g. surgery, endoscopy, colonoscopy, interventional radiology). To be relevant for surgery, that documentation is time sensitive, as old data does not accurately reflect the current state of the patient's health. Different data pieces have different time sensitivity. Changes in medical procedure scheduling dates may invalidate previously relevant data.

Pre-operative/pre-procedure interviewing and screening of patients by designated health professionals identifies previously undisclosed health and social issues which may interfere with completion of the scheduled medical procedure. Recognition of these issues allows for the issues to be addressed and may eliminate the obstacles to successful completion of a medical procedure.

As always, communication between involved parties (physicians, scheduling personnel and document coordinators) is essential for efficient workflow. Tying all relevant communications to the underlying documents expedites the process.

Further, domestic and international laws (HIPAA and ISO/IEC 17799) establish strict privacy standards for health information transfer. Thus, all document collection, transfer and review, and all patient-related communications must be secure and comply with privacy standards.

### BRIEF DESCRIPTION OF THE DRAWINGS

FIG. 1A is a block diagram illustrating the structure and operating environment for a surgical document management system.

FIG. 1B is a block diagram illustrating the computing environment for the surgical document management system of FIG. 1A.

FIG. 2A is a flow diagram showing one embodiment of a process for submitting a surgery scheduling request.

FIG. 2B is a flow diagram showing additional details of the process of FIG. 2A.

FIG. 3 is an exemplary screen shot illustrating a web form for making a surgery scheduling request.

FIG. 4 is an exemplary screen shot illustrating a pop-up window that appears over the web form of FIG. 3.

FIG. 5 is an exemplary screen shot illustrating a worklist for the surgery scheduling request.

FIG. 6 is an exemplary screen shot illustrating a pop-up window that appears over the worklist of FIG. 5.

FIG. 7A is a flow diagram showing one embodiment of a process for coordinating document collection for the surgery scheduling request.

FIG. 7B is a flow diagram showing additional details of the process of FIG. 7A.

FIG. 8 is an exemplary screen shot illustrating a document inbox for the doctor associated with the surgery scheduling request.

FIG. 9 is an exemplary screen shot illustrating an opened document in the document inbox of FIG. 8.

FIG. 10 is an exemplary screen shot illustrating a document inbox for the facilities document clerk associated with the surgery scheduling request.

FIG. 11 is an exemplary screen shot illustrating a document worklist associated with the surgery scheduling request.

FIG. 12 is an exemplary screen shot illustrating a pop-up window appearing over the document worklist of FIG. 11.

FIG. 13 is an exemplary screen shot illustrating a scheduling tool for pre-operative visits.

FIG. 14 is an exemplary screen shot illustrating a pop-up window for overriding the status of a document.

FIG. 15 is an exemplary screen shot illustrating a secure message mailbox.

FIG. 16 is an exemplary screen shot illustrating a dashboard that summarizes the status of all surgery scheduling requests for the facilities clerk.

### DETAILED DESCRIPTION

1. System Operating Environment

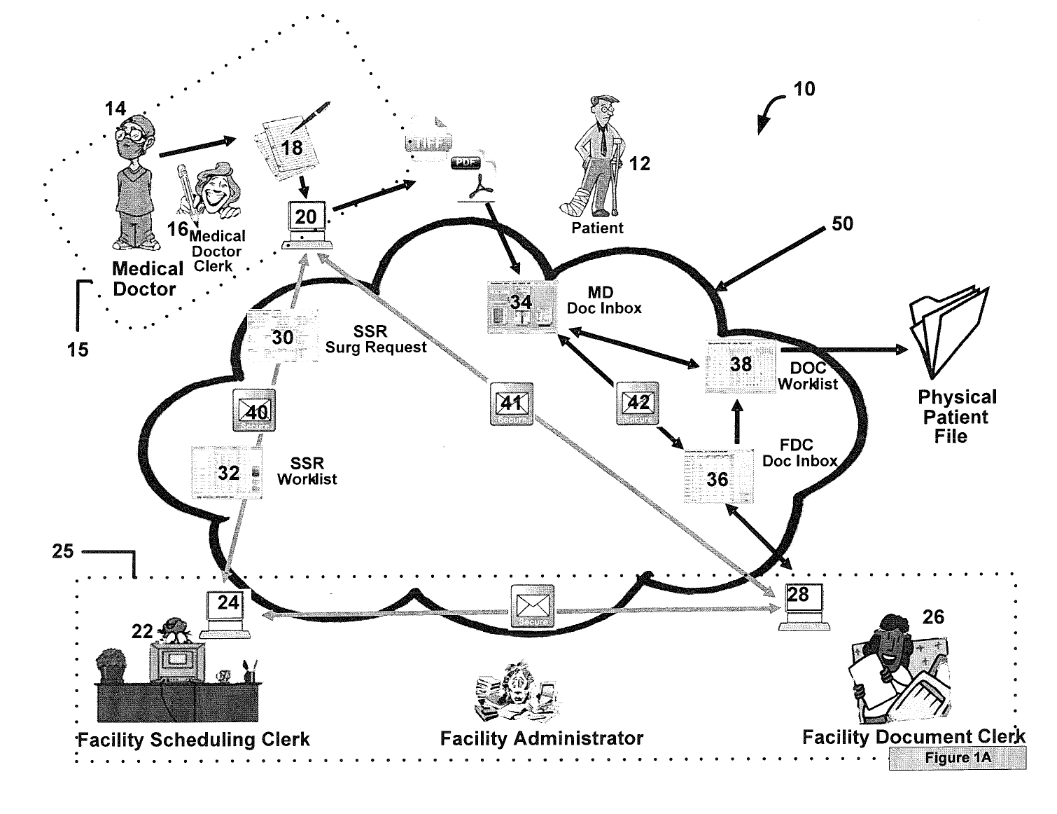

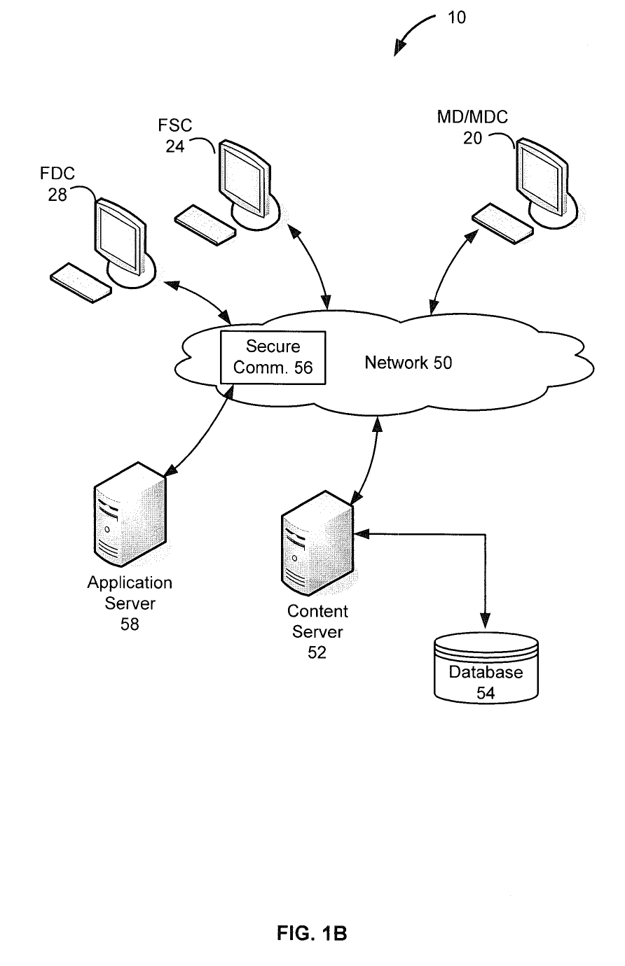

Referring to FIG. 1A, the basic structure of a surgical document management system 10 is illustrated. A patient 12 of doctor (“MD”) 14 requires surgery. The MD 12 has an office 15 and employs a clerk (“MDC”) 16 in the office to assist him with clerical duties, such as preparing and maintaining physical patient files 18, as well as electronic patient files (not shown) on office computer 20.

In order to evaluate the need for surgery on patient 12, the MD 14 will have conducted a physical exam of the patient, worked up the patient's medical history, and ordered one or more tests for the patient. All this information is ultimately collected into the patient file 18 at the doctor's office 15.

Upon being satisfied that surgery on the patient is indicated, the MD 14 (or the MDC 16) needs to schedule the procedure with a surgery facility 25. The surgery facility 25 employs a facility scheduling clerk (“FSC”) 22 who takes surgery scheduling requests (“SSRs”) 30 from doctors such as MD 14 via a secure messaging platform 40 into office computer 24, then reviews and acts on the SSRs. The action of the FSC 22 with regard to an SSR 30 is reported back to the MD/MDC via secure messaging 40. Alternatively, or in addition to secure messaging, the action may be reported on an SSR work-list 32, which is a status report for all SSRs. If the action of the FSC 22 approves the SSR 30, then the MD/MDC must affirmatively respond and confirm the SSR.

The surgery facility 25 also employs a facility document clerk (“FDC”) 26 who is responsible for managing the documentation required to support the SSR. The FDC 26 uses computer 28 to manage the documentation and to communicate with the MD/MDC through secure messaging platform 42 to coordinate the collection, validation, approval and transfer of required or desired documentation for the surgery. For example, a software application as described herein for surgical document management is hosted remotely and accessible through a content server 52 on network 50 (see FIG. 1B). The application defines a document inbox 34 for the MD 14 on the server and a document inbox 36 for the FDC 26 on the server. The MD document inbox 34 is accessible through the network 50 using computer 20 at doctor's office 15, and the FDC inbox 36 is accessible through the network using computer 28 at the surgical facility 25. Documents can be securely transferred between the MD inbox 34 and the FDC inbox 36 via a secure document transfer platform 42. In addition, a document worklist 38 is maintained and shared between the MD/MDC and the FDC to reflect the status of all documents specified for a particular medical procedure.

Each of the local computers 20, 24, 28 may be standalone computer systems having local storage which are interconnected through a network 50, such as the internet, as further illustrated in FIG. 1B. In the computing environment of the surgical document management system, each of the computers 20, 24, 28 has access to a content server 52 through the network 50. The business rules for surgery and document management as described herein are defined and reside on the content server 52. However, various rules/parameters/preferences can be established for a particular facility (whether a doctor's office a surgical facility, or a document management facility) and configured through the local computer(s) on initial set-up or changed by an authorized user (such as a Facility Administrator). The content server 52 may be located anywhere, and the notion of cloud computing may be employed to locate the server with a third party host who provides services to multiple entities. The content server 52 manages a database 54, and the resources of the content server and database may be used to store and retrieve documentation as specified herein. Secure messaging and document transfer may be provided through a secure communications program 56, accessible to computers 20, 24, 28 through network 50. For example, stored data may be encrypted using well known techniques, and data in transit may be securely transferred using well known SSL (Secure Socket Layer) techniques. The software application is hosted by a third party application server 58 and must comply with data privacy laws such as HIPAA and ISO3TEC 17799.

It should be appreciated that embodiments can be implemented in numerous ways, including as a process, an apparatus, a system, a device, a method, a computer readable medium such as a non-transitory computer readable storage medium containing computer readable instructions or computer program code, or as a computer program product comprising a computer usable medium having a computer readable program code embodied therein.

In the context of this document, a computer usable medium or computer readable medium may be any non-transitory medium that can contain or store program instructions for use by or in connection with an instruction execution system, apparatus or device. For example, the computer readable storage medium or computer usable medium may be, but is not limited to, a random access memory (RAM), read-only memory (ROM), or a persistent store, such as a mass storage device, hard drives, CDROM, DVDROM, tape, erasable programmable read-only memory (EPROM or flash memory), or any magnetic, electromagnetic, infrared, optical, or electrical system, apparatus or device for storing information. Alternatively or additionally, the computer readable storage medium or computer usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory.

Applications, software programs or computer readable instructions may be referred to as components or modules. Applications may be hardwired or hard coded in hardware or take the form of software executing on a general purpose computer such that when the software is loaded into and/or executed by the computer, the computer becomes an apparatus for practicing an embodiment. Applications may also be downloaded in whole or in part through the use of a software development kit or toolkit that enables the creation and implementation of an embodiment. In this specification, these implementations, or any other form that an embodiment may take, may be referred to as techniques. In general, the order of the steps of disclosed processes may be altered within the scope of this disclosure.

2. Scheduling Procedures

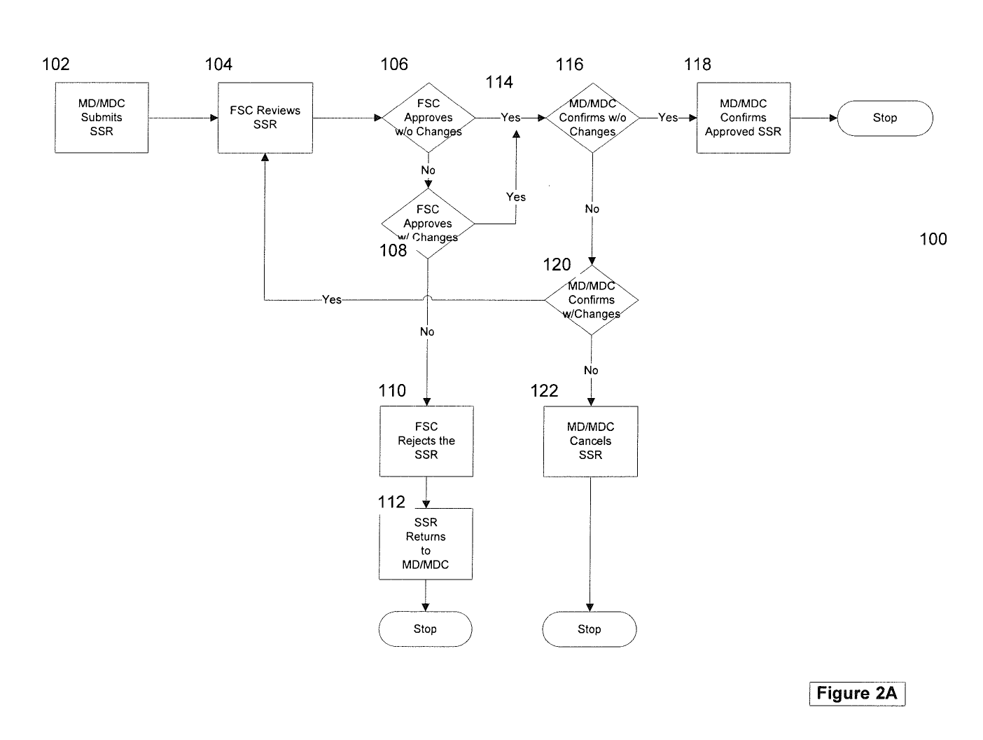

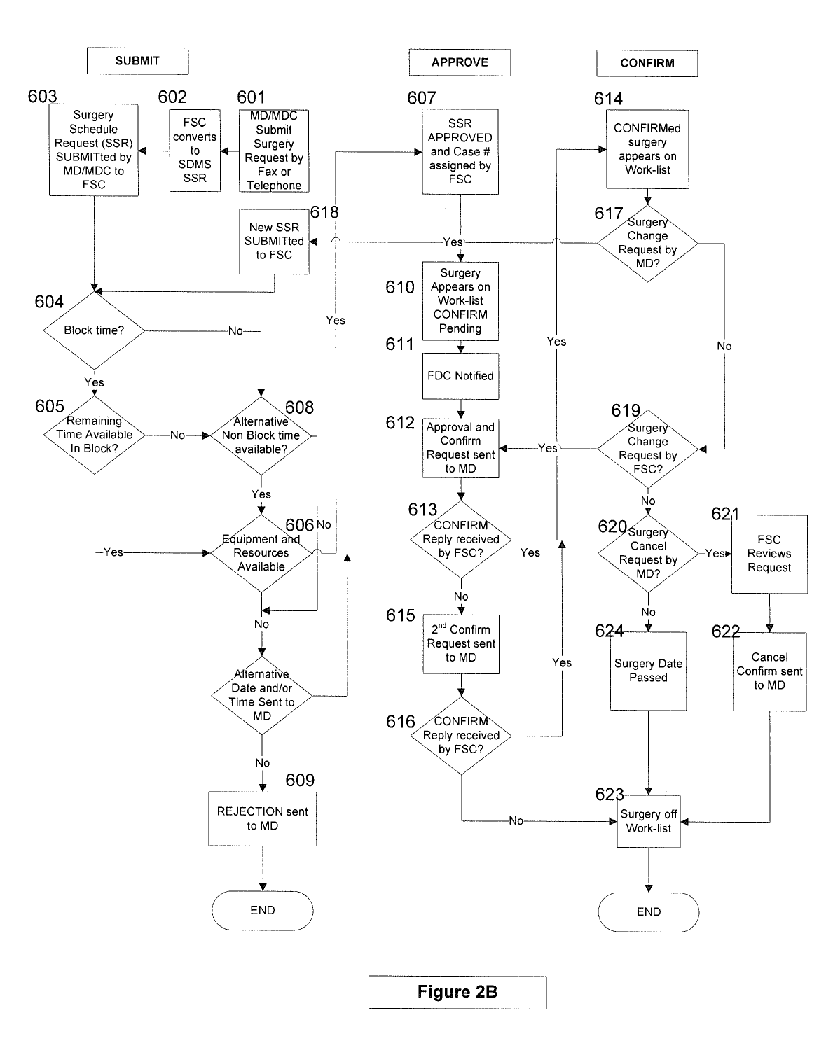

Referring now to FIG. 2A, a process 100 for scheduling a medical procedure is illustrated. The process 100 is implemented in software with a scheduling application accessible to users through network 50.

In step 102, an SSR is generated for a specific, surgery facility. The SSR is typically generated by the MD or the MDC, and is received and reviewed by the FSC at the surgery facility in step 104. Preferably, an electronic digital signature is required to submit the SSR.

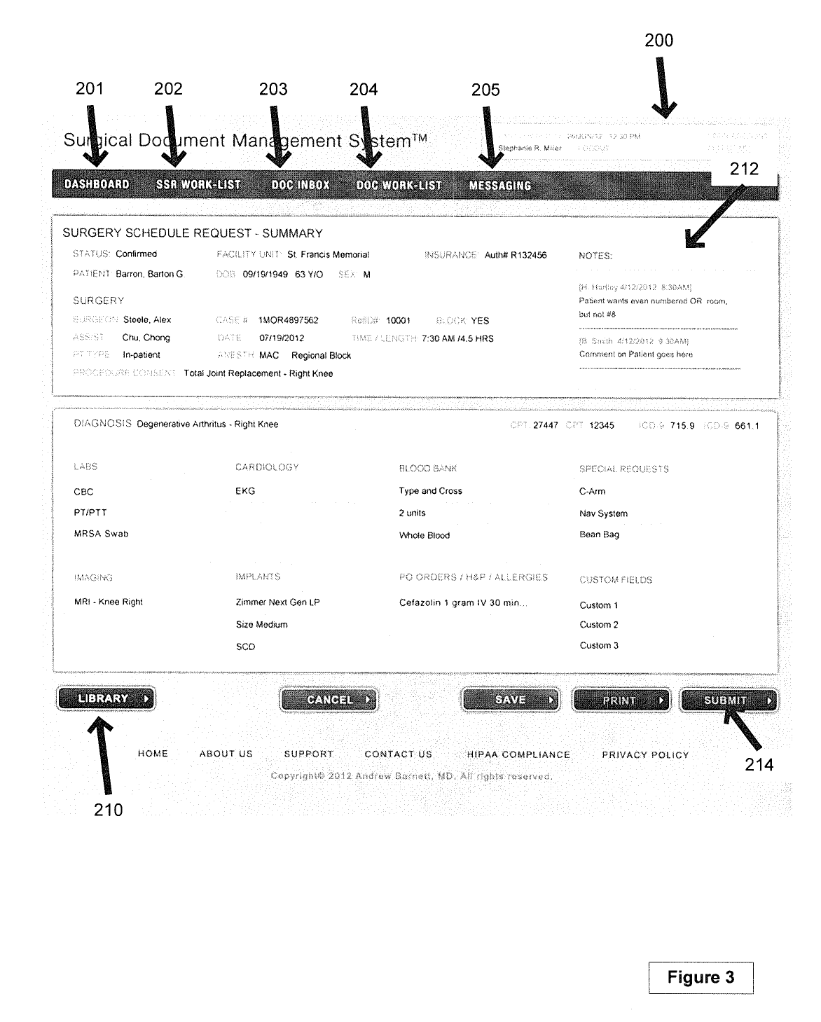

A graphical user interface 200 for the surgical document management system may be provided to facilitate initiating and handling the SSR, as illustrated in FIG. 3, described in more detail below. Thus, the MD or MDC may initiate the SSR by filling out and submitting a web-based form.

In step 106, the FSC determines whether the SSR can be approved without changes. If not, then in step 108, the FSC determines whether the SSR can be approved with changes. If not, then the SSR is rejected by the FSC in step 110. The FSC then notifies the MD/MDC of the rejection and the reasons for the rejection in step 112, and the process ends.

If the SSR can be approved by the FSC without changes in step 106, or with changes in step 108, then the MD/MDC is notified of the acceptance of the SSR in step 114. If the MD/MDC is able to confirm the SSR without making any additional changes in step 116, then the MD/MDC sends a confirmation of the SSR to the FSC in step 118 and the process ends.

If the MD/MDC is not able to confirm the SSR without making any additional changes in step 116, then the question is whether the MD/MDC is able to confirm the SSR with changes in step 120. If so, then those changes will need to be reviewed by the FSC again, and the process returns to step 104 to do so. If the MD/MDC is not able to confirm the SSR with changes in step 120, then he cancels the SSR in step 122 and the process ends.

Returning to FIG. 3, the MD/MDC has the option to enter an SSR from scratch into the fields of GUI 200, or to recall a previously created or partially filled-in SSR by selecting the LIBRARY button 210 from GUI 200 and choosing a saved file. In one embodiment, the LIBRARY could contain a number of forms that are created and customized ahead of time for different types of surgeries. Thus, the MD or MDC could select an existing form that requires only a limited amount of information to be entered, such as the patient information, the requested date and start time.

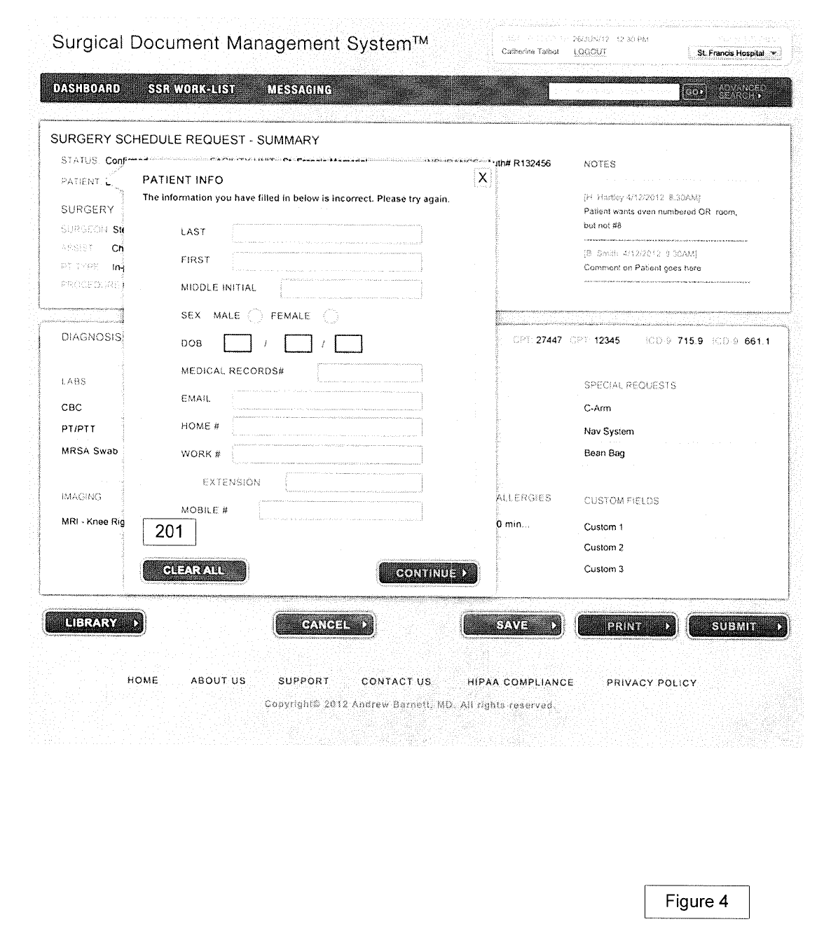

The SSR web form GUI 200 may be configured with multiple pop-up windows to populate certain fields. In one embodiment, the fields on GUI 200 requiring fill-in data have titles in uppercase lettering and act as hyperlinks to the pop-up windows when the user clicks on a title. For example, clicking on the PATIENT link on GUI 200 generates pop-up window 201 as shown in FIG. 4, with multiple fields for entering patient information.

If the MD/MDC realizes that edits to the SSR information are needed, she'll be able to go back and make those edits. However, these edits may have an impact on workflow, as further described below, and such workflow parameters can be configured by the an administrator at the surgery facility, for example. Any edits to the SSR made after its initial submission are referred to as SSR Changes.

When an SSR is first created, the user can enter or edit text into the Notes field 212. However, once the SSR has been submitted, i.e., by clicking on the SUBMIT button 214, the notes cannot be edited, but any user with access to the SSR (i.e., the MDC, MD, FSC and FDC) can add additional notes as a thread. The system tracks the notes added by each user with a date/time stamp, which is displayed in-line with each note.

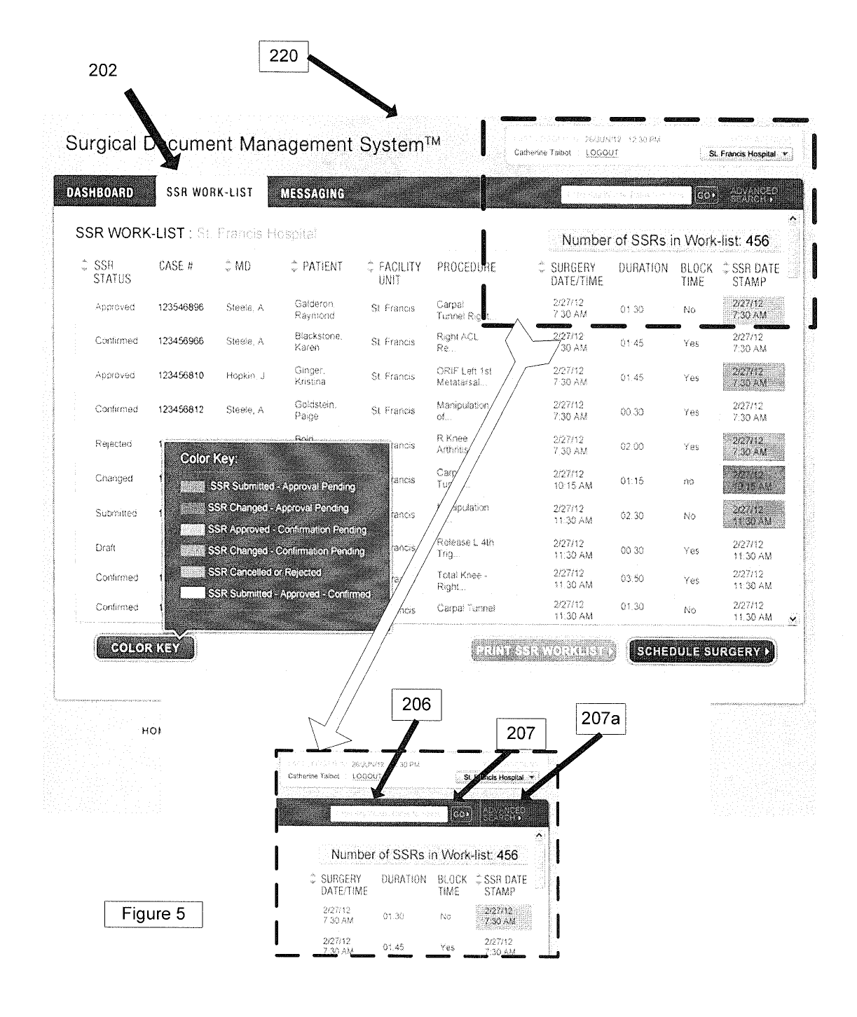

As noted above, the FSC reviews the SSR in step 104. In one embodiment, the FSC selects a tab 202 on GUI 200 entitled SSR WORK-LIST, and a listing of all SSR's is presented in window 220 (which corresponds to tab 202), as shown in FIG. 5. For example, the listing of SSR's in window 220 includes the following information organized as columns: SSR Status; Case No.; MD; Patient; Facility; Procedure; Surgery date/time; Duration of Surgery; Block time; and SSR date stamp.

In one embodiment, there are seven different status states for an SSR, as shown in Table I below.

TABLE I

| SSR | | |
|---|---|---|
| Status | User | Explanation |
| Draft | MD/MDC | Info has been entered, but the SSR has not |
| | | been submitted; draft saved for later |
| | | review, can be modified or deleted |
| Submitted | MD/MDC | The SSR has been submitted or re-submitted |
| | | and is awaiting approval from the FSC |
| Approved | FSC | The request has been approved (or approved |
| | | with changes) by the FSC and is awaiting |
| | | confirmation from the MD/MDC |
| Confirmed | MD/MDC | The MD/MDC Confirms the SSR after approval |
| | | by the FSC |
| Rejected | FSC | The FSC rejects the SSR before it is approved |
| Cancelled | MD/MDC | After approval, the FSC or MD/MDC cancels |
| | or FSC | the SSR. |
| | | The SSR may be cancelled automatically if: |
| | | (1) the MD/MDC does not confirm the |
| | | approved SSR within X days after approval; |
| | | (2) A warning Secure Message is sent from |
| | | the FSC to the MD (sent automatically |
| | | if MD does not Confirm by X days, and |
| | | (3) Y days pass without Confirmation from |
| | | MD after warning secure message is sent. |
| | | The values of X and Y can be configured |
| | | by the Facility |
| Completed | N/A | The Surgery was Confirmed and the Surgery |
| | | Date & Time is before the Current Date & Time |

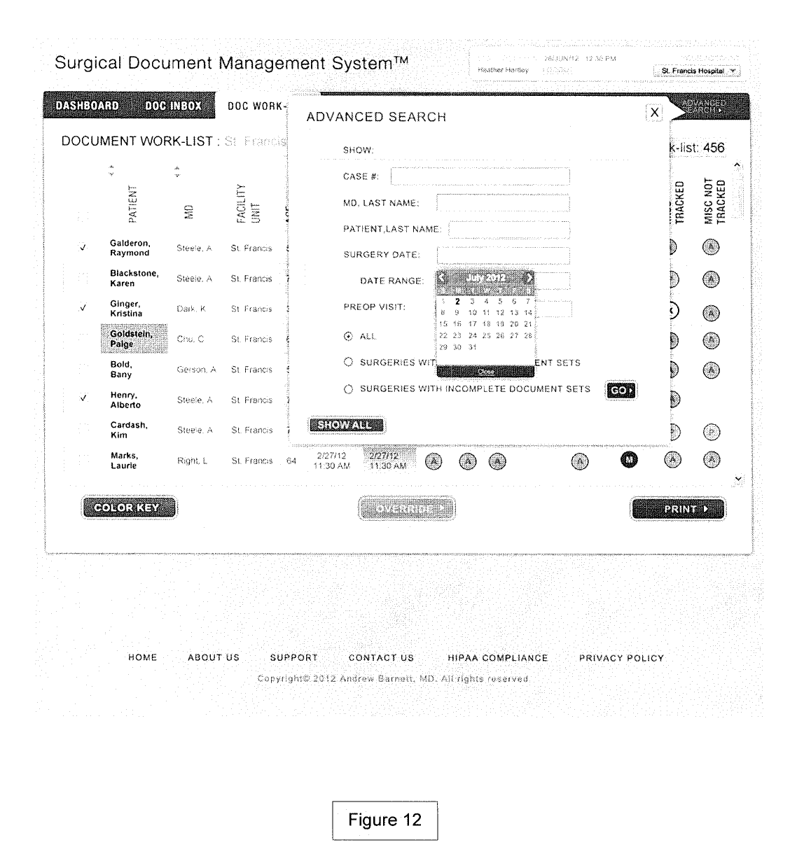

The user can conduct a Quick Search for Documents in the SSR work-list by entering terms into the search field 206 and pressing the search button 207 to conduct a universal key word search. An Advanced Search may be conducted by pressing button 207a which reveals a popup window with context sensitive advanced search criteria (not shown), similar to the Advanced Search popup window shown in FIG. 12. This Advanced Search popup window contains individual fields that may be populated with search terms. The fields provided in an advanced search form may include surgery date, MD, patient and case number. Further, the search form may include one or more filters, such as all SSR's, SSR's Submitted, SSR's Approved, SSR's Confirmed, SSR's Cancelled and SSR's Rejected (not shown.)

Search results, both Quick Search and Advanced Search, may be displayed in the SSR Work-list in this example.

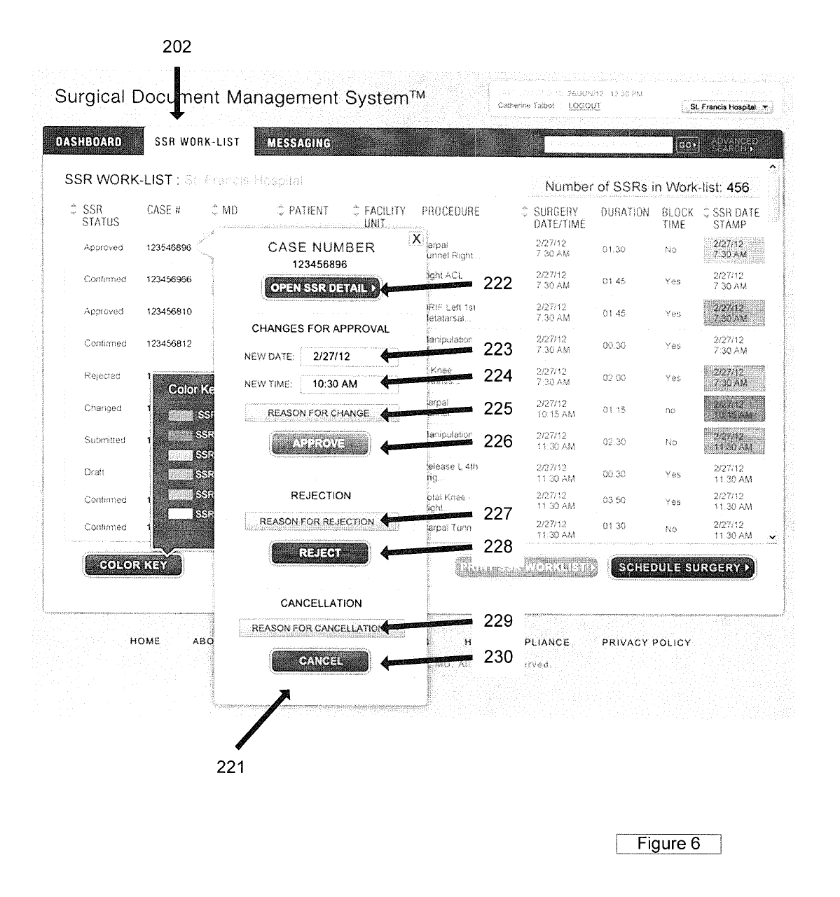

When the SSR is first submitted in step 102, it appears on the top line of the SSR Work-List 202 without any entry in the cell for case number. The FSC then clicks on the blank case number cell and a pop-up window 221 appears, as illustrated in FIG. 6. The FSC assigns a case number according to the policies and procedures of that facility. The pop-up window 221 may be configured with a number of widgets or buttons that allow the FSC to review details of the SSR and to approve, modify, or reject the proposed SSR. For example, button 222 allows the FSC to open up and view the entire record for that case number. If the FSC needs or wants to change the proposed time for the SSR, for any reason, then the new date will be entered into date field 223 and the new time will be entered into time field 224. Widget 225 is a pull-down menu with a list of standard reasons that the surgery schedule might be changed, such as the availability of specialized equipment resources at the scheduled time, overlap with an earlier surgery scheduled in the same operating room, etc. The FSC can select the appropriate reason from the pull-down menu 225, then click the APPROVE button 226 to save the proposed changes to the SSR.

Scenario 1—Approval:

If the proposed date and time are acceptable to the FSC, then the FSC assigns a case number for the medical procedure requested and clicks the APPROVE button 226. The case number is an alpha-numeric reference generated by the surgical facility unit, and is intended to be unique to that facility.

Scenario 2—Approval with Changes:

If the proposed date and time for the medical procedure do not work for the facility for any reason, then the FSC may make propose an alternative date by entering it in field 223 and/or an alternative time by entering it in field 224. The FSC assigns a case number and clicks the APPROVE button 226. Further, a pull-down widget 225 may be provided on pop-up window 221 and configured with a list of standard reasons for the change, such as a conflict with another procedure scheduled at that facility unit.

Scenario 3—Reject:

If the proposed date and time are completely unacceptable to the FSC, and there is no apparent simple change that would be acceptable, then the FSC rejects the SSR by clicking the REJECT button 228. A pull-down widget 227 is configured with a list of standard reasons for the rejection, such as unavailability of the facility unit. A case number is not assigned for an SSR that is rejected. However, once the SSR is approved, it can no longer be rejected, although it could be cancelled (see below).

In all three Scenarios, the SSR is returned electronically to the MD/MDC with the response of the FSC.

After the FSC responds to the SSR request, the SSR appears in the SSR Work-List 202 along with the FSC response status. When the MD/MDC returns to the SSR Work-List, he then clicks on the case number, a pop-up window appears (not shown), allowing the MD/MDC to confirm the scheduling of the SSR request.

If the MD/MDC fails to confirm the scheduling of the SSR request, the SSR will be automatically cancelled. In one embodiment, cancellation will occur after the following three events: (1) the MD/MDC does not confirm the SSR scheduling within a set number of days after FSC approval; (2) a secure warning message is sent from the FSC to the MD/MDC; and (3) the MD/MDC does not confirm the SSR scheduling within a set number of days after secure warning message is sent. The number of days criteria may be set by the FSC or by policy of the surgical facility. Also, the secure warning message may be sent automatically by the scheduling system if the MD/MDC has not confirmed within a set number of days.

Changes to selected fields of the SSR request by the MD/MDC, which are configurable by the surgical facility, requires that the SSR request be resubmitted to the FSC. For example, changes to the surgery date, start time, duration and special instrumentation needs, necessitate a resubmission of the SSR request.

A more detailed process workflow 600 for scheduling is shown in FIG. 2B. In step 601, the MD/MDC contacts the FSC by fax or telephone to submit a surgery request. This step is not part of the surgery document management system, but the system has the flexibility to allow MD/MDC scheduling outside the system, using legacy methods such as telephone or fax. In step 602, the FSC converts the legacy paper or voice based request to an electronic SSR by filling out the web form, saving it, and sending it to the MD/MDC. In step 603, the MD/MDC submits the SSR to the FSC for approval.

In step 604, the FSC consults the surgery schedule for that facility and determines first if the requested time falls within the scheduling MD's Block Time. Block Time is a special case where an MD “owns” a block of time in a specified Operating Room, and hence, a specified time on the Surgery Schedule. This time is for the exclusive use of the MD, unless he releases all or a portion of the Block Time. Notwithstanding this “ownership”, the FSC must still determine if other limited resources, such as specialized equipment, or key support personnel, are also available during the Block Time. Absence of the limited resources may result in an SSR falling within a Block Time not being approved. The FSC must also determine, in step 605, if there is an adequate time period remaining in the Block Time to satisfy the duration of surgery specified in the SSR If so, then in step 606, the FSC determines whether there are adequate equipment and resources available for the requested surgery. If so, then the FSC approves the SSR in step 607.

If an SSR is proposed for a time that is not in an MD's Block Time in step 604, or if there is not adequate time remaining in the Block Time to fulfill the time requested for surgery in the SSR in step 605, the FSC will look on the surgery schedule to see if the requested time can be fulfilled by a non-Block Time alternative block of time in another operating room in step 608. If so, then the FSC determines whether there are adequate equipment and resources available for the requested surgery in step 606. If so, then the SSR is approved by the FSC in step 607. If not, then the SSR is rejected by the FSC in step 609.

Once the SSR is approved in step 607, the surgery is listed on the SSR worklist in step 610 with a status of confirmation pending, and the FDC is notified in step 611. The approval is sent to the MD in step 612 with a request that the MD confirm the scheduling. If a confirmation of the scheduled surgery is received by the FSC in step 613, then the status of this SSR on the worklist is changed to CONFIRMED in step 614.

If confirmation by the MD has not been received within a set number of days, then a second request for confirmation is sent to the MD in step 615. If the confirmation is then received in step 616, then the status of the SSR on the worklist is changed to CONFIRMED in step 614.

Once the SSR has been approved by the FSC and confirmed by the MD, the MD may request a change to the SSR. If a change is requested by the MD in step 617, then the existing SSR must be cancelled by the MD and a new SSR prepared and submitted to the FSC in step 618. The SSR is then returned to step 604 for further processing.

If the MD has not made a change request, the FSC could still make a change request. If the FSC makes a change request in step 619, then the existing SSR is not cancelled but is modified, then sent to the MD requesting a new confirmation in step 612.

If the FSC does not make a change request in step 619, the question of whether the MD has made a request to cancel the SSR is considered in step 620. If so, then the FSC reviews the request in step 621, then sends a confirmation of the cancel request to the MD in step 622. In step 623, the surgery is removed from the SSR worklist.

If the MD has not made a cancellation request, but the surgery date has passed in step 624, then the surgery is removed from the SSR worklist in step 623

3. Post-Approval Procedures

Once the SSR request is approved by the FSC and confirmed by the MD/MDC (whether an initial request or resubmitted with changes), the reject button 228 in pop-up window 221 (FIG. 6) is inoperative and greyed out, and instead the cancel button 230 is active, including a pull-down menu 229 providing a list of standard reasons for cancellation.

When the SSR has been approved and confirmed, it appears in the document Work-List 202 for both the MD and the FSC. This serves as a notification to both the MD and the FSC that the underlying surgery is set on the surgery schedule for that facility.

When the FSC cancels a scheduled surgery for a patient with only a single surgery scheduled, the FDC is notified so that patient document tracking is stopped. This notification may be accomplished three ways: (1) a secure message is automatically sent to the FDC; (2) the patient record is removed from the document work-list 204; and (3) documents tied to the underlying patient/surgery are removed from the FDC document inbox 203.

If the patient tied to the SSR has more than one surgery scheduled at the surgical facility, then the documents are not returned to the FDC document inbox 203, but instead, the document tags are changed to reflect the next surgery date scheduled for that patient, assuming that the surgery is tied to the same MD. At this point, these documents must be re-approved by the FSC. If there are no other surgeries scheduled for this patient that fulfill these criteria, the documents are not returned to the FDC Document Inbox. However, the documents do appear in the document inbox 203 for the MD with an indicator showing the rejected status.

If the MD/MDC cancels a previously approved SSR (or previously approved and confirmed), a message is triggered and sent to the FSC and FDC informing them of the cancellation.

A previously rejected or cancelled SSR can be revived by the MD and resubmitted. This is equivalent to a new SSR request. The FSC will then respond as described above. In one embodiment, an SSR may only be resubmitted by the MD/MDC for a set number of days after the SSR was cancelled or the SSR was rejected.

The system also preferably includes an audit trail to keep track of who added, edited, viewed, submitted, approved, confirmed, rejected, revived, etc. every SSR.

4. Document Management

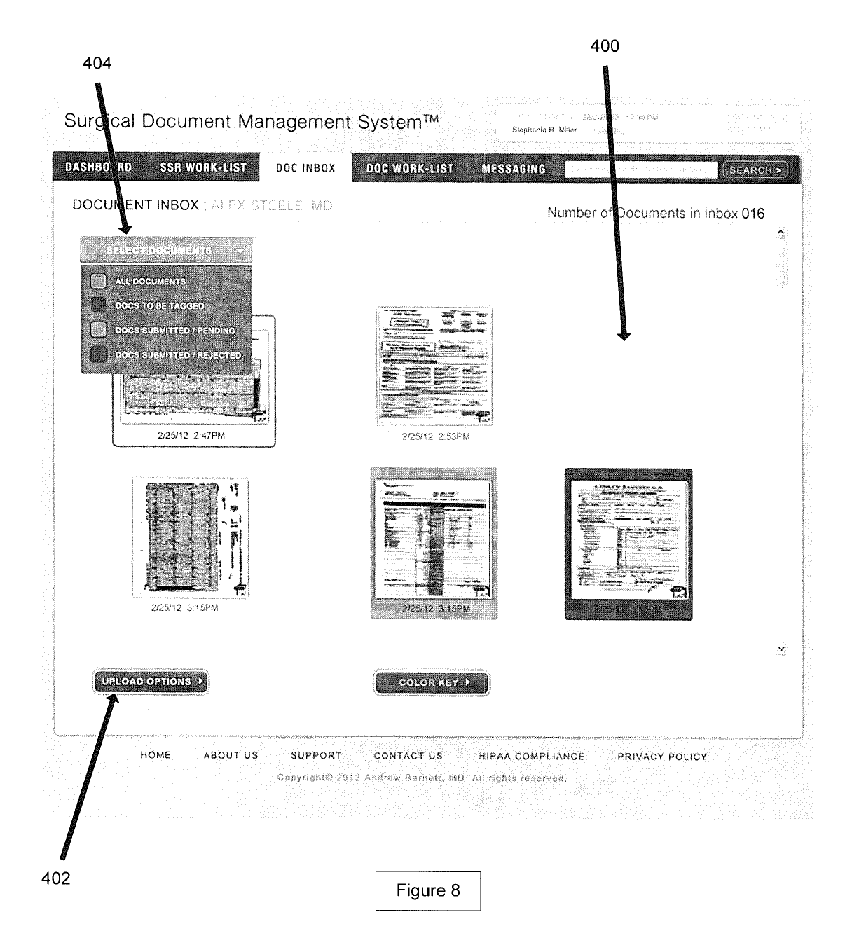

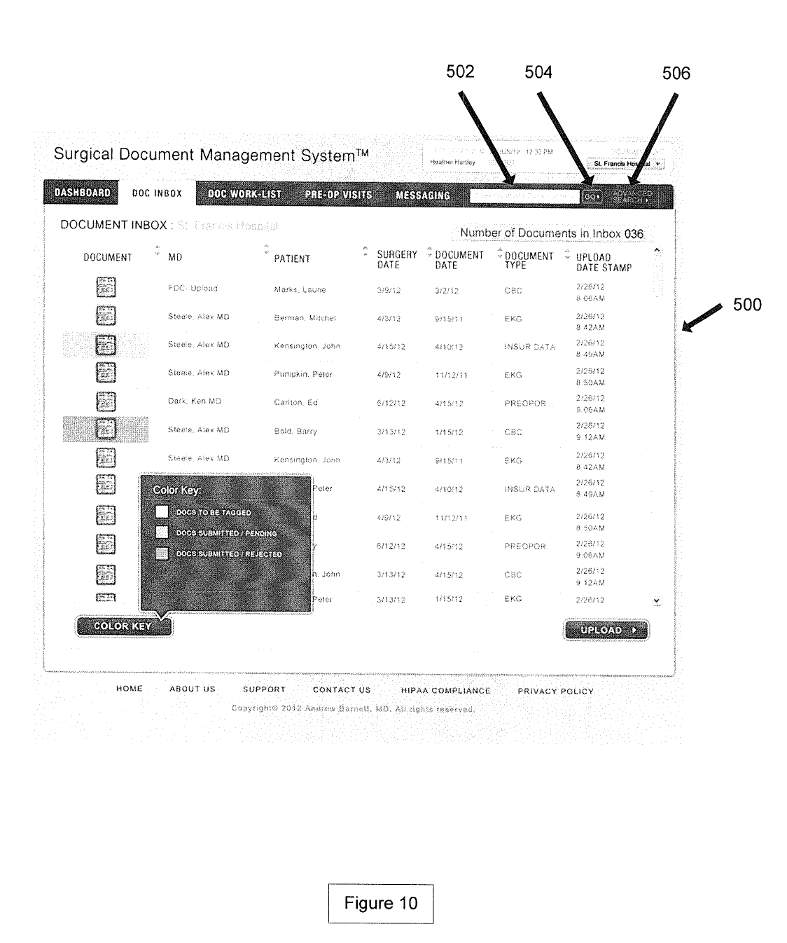

Once a patient is scheduled for surgery, a number of “documents” are either required or optional, but all documents associated with the patient and their medical procedure must be submitted to the surgical facility in advance of the surgery date. The documents are usually uploaded to the document inbox for the MD/MDC (see FIG. 8), then tagged with appropriate notes or other information by the MD/MDC. Following tagging by the MD/MDC, the documents then appear in the document inbox for the FSC/FDC (see FIG. 10). These documents are reviewed by the FSC and then filed in the electronic chart for the patient.

It is the responsibility of the MD/MDC to make sure that the appropriate documents are at the surgical facility in advance of the surgery date by uploading the documents to the FDC inbox at the surgical facility. It is the responsibility of the FDC (1) to review all documents uploaded to the surgical facility; (2) to accept or reject the uploaded documents; (3) to file the accepted documents in the patient's electronic chart; and (4) to return the rejected documents to the MD/MDC and notify the MD/MDC of the rejection. In general, the FDC must track the status of the electronic charts of all future patient surgeries with regard to the presence of required and optional documents to determine whether the patient's electronic chart is complete or incomplete.

The MD/MDC and the FDC are both provided with a document inbox 203 where documents are reviewed and tagged with required identifying information, and a document work-list 204 where the documents are tracked. However, the document inbox in each location is different in appearance and not shared.

The MD/MDC and FDC share a common, identical view of the document work-list 204, the only difference being that the work-list for the FDC includes all the documents that are tagged to the specific surgical facility of that FDC from many MD's, while the work-list for the MD/MDC includes all documents that are tagged to the specific MD.

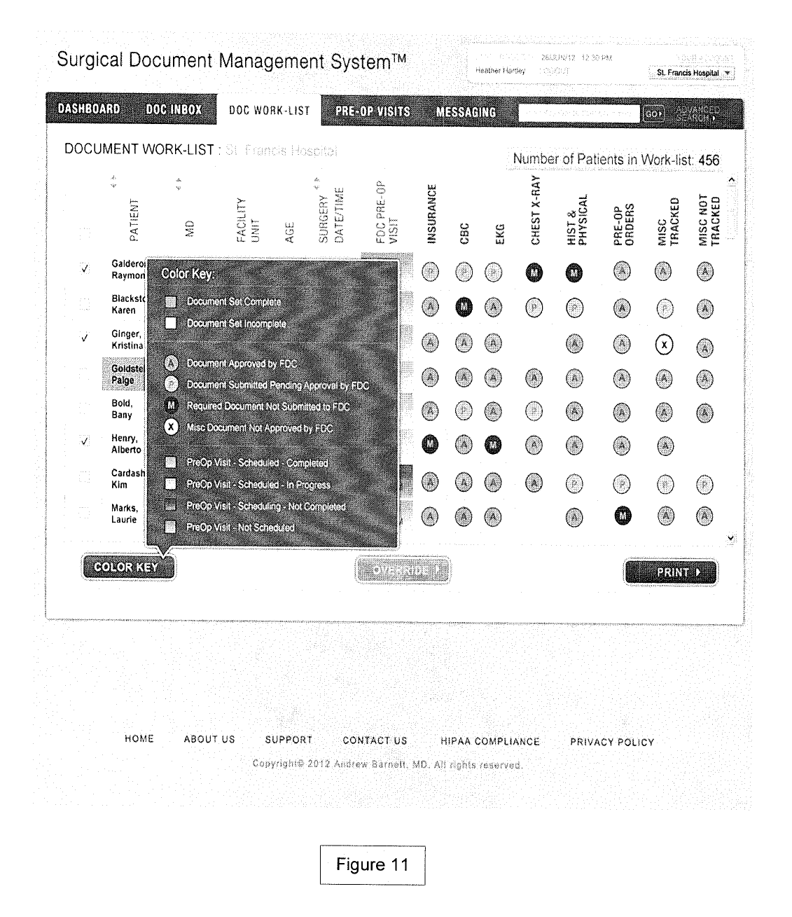

As illustrated in FIG. 11, the document work-list 204 is a table having rows representing scheduled surgery records, with one patient and one surgery per line. The term “document” refers to a unique entity that is patient specific and may be unique to a specific surgery. Some examples of documents include: (1) the SSR (web form); (2) insurance information; (3) pre-operative visit at the surgical facility (this is the only “document” generated by the FDC independent of the MD/MDC); (4) CBC (complete blood count); (5) EKG (electrocardiogram); (6) chest x-ray; (7) patient history and physical; (8) pre-operative orders; and (9) other miscellaneous documents.

At some point prior to the scheduled surgery date, the FDC will print hard copies of documents in the document inbox 203 and place them in the patient's physical chart. Note that some documents are certificates that point to a unique entity, and such documents are not physically placed into the patient chart. For example, a chest x-ray is represented by an imaging certificate that identifies the location of the specific chest x-ray. The certificate is printed and placed in the patient's physical chart.

Certain documents are designated as “core documents” because they are usually (but not always) required by surgical facilities to be completed and available in a patient's chart prior to the day of surgery. In one embodiment, the following default conditions are used for processing documents:

(1) The surgical facility can configure which documents are required and all its Facility Units must use the same defaults;

(2) The document management system can apply intelligent rules, based on parameters set by the surgical facility, for determining exceptions to the need for a required document. For example, the surgical facility may specify that a CBC is only required for patients over a certain age.

(3) When the MD/MDC indicates on the SSR web form that a document is required for the medical procedure, that document is tracked in the document work-list. The patient's e-chart (i.e., document set) is complete when all the tracked documents have been approved by the FDC.

(4) When the MD/MDC uploads documents that are not identified in the SSR web form, those documents are not tracked. Thus, while the FDC still has to approve documents that are not tracked, such documents will not affect the status of the e-chart.

The status of a document can be as shown in Table II below:

TABLE II

| Status | User | Explanation |
|---|---|---|
| Uploaded | N/A | Document has been uploaded to the document |
| | | inbox and has not been tagged |
| Missing | N/A | A tracked document has not been submitted |
| | | to the FDC. (not-tracked documents are |
| | | never considered missing) |
| Submitted | MD/MDC | The document has been tagged and submitted |
| | | to the FDC for approval. All documents must |
| | | be submitted to the FDC for approval, even |
| | | not-tracked documents |
| Approved | FDC | The document has been approved by the FDC |
| | | (both tracked and not-tracked documents) |
| Rejected | FDC | The document has been rejected by the FDC |
| | | (not-tracked documents are rejected only if |
| | | the tag placed by the MD/MDC is not correct) |

5. Document Process Workflow

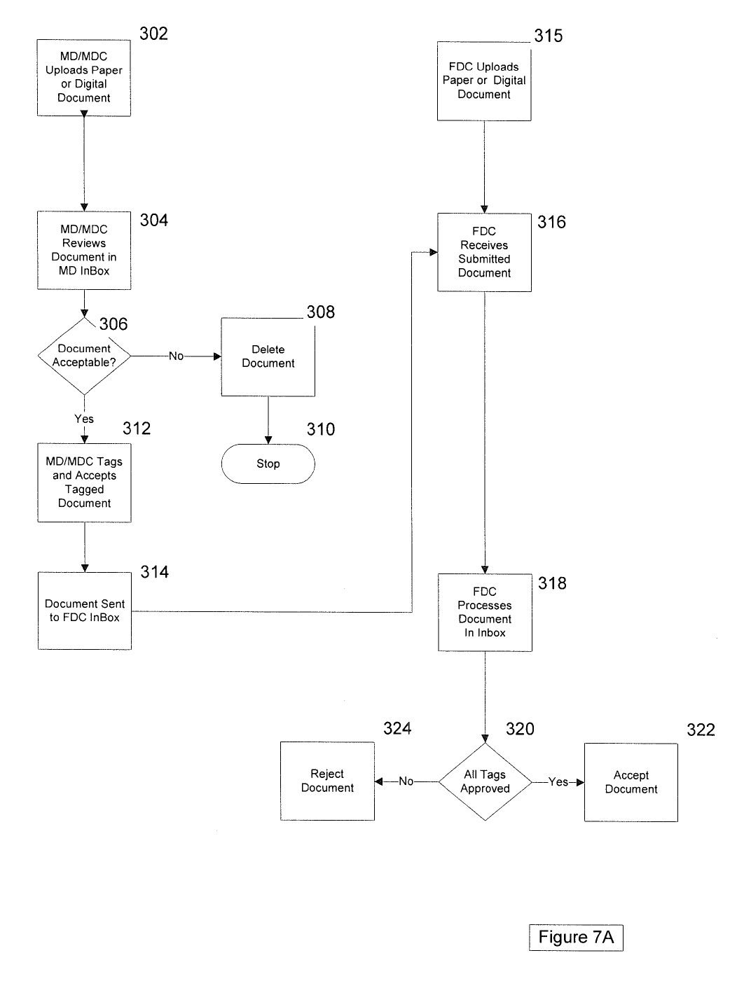

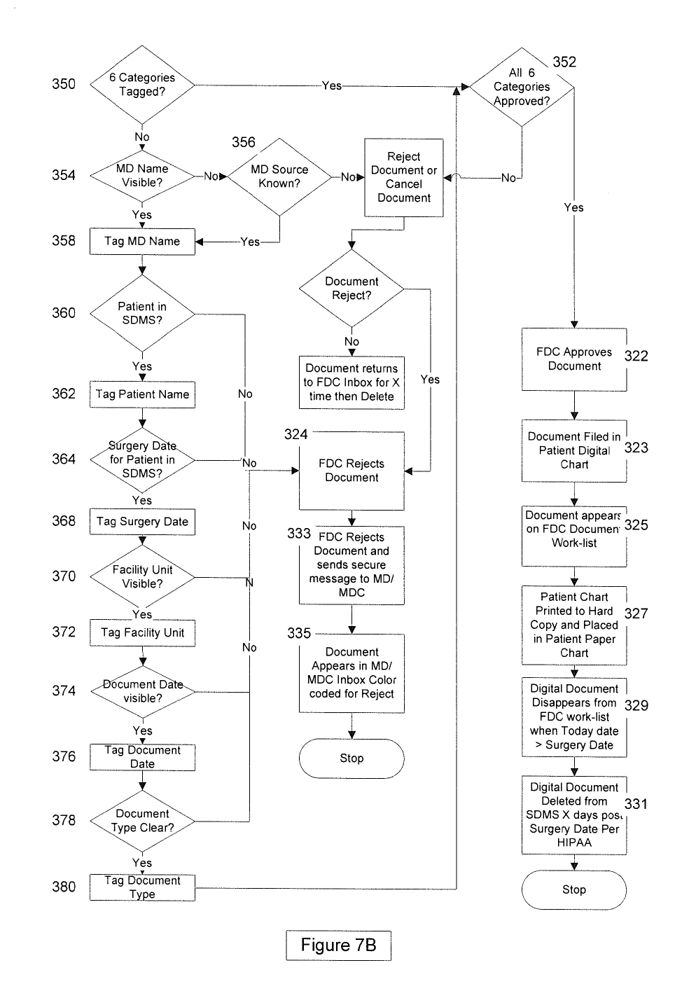

A process 300 for handling a single document is illustrated in FIG. 7A. In step 302, a document is uploaded by MD/MDC into the document inbox of the MD on the server. For example, a document can be a faxed to a third party fax server that is HIPAA compliant. In one embodiment, the identity of the MD may be bar coded onto the fax cover page so that all documents uploaded in that batch are tagged with the identity of the MD and the upload date/time and automatically routed to the MD Inbox.

A document may also be scanned into a user's personal computer without any tags, and the document management system includes an option to upload documents directly into the inbox on the server. For example, FIG. 8 shows window 400 representing the MD document inbox, with a button 402 entitled UPLOAD OPTIONS that when selected, provides user selectable options for uploading documents to the inbox. An option may also be provided to operate scanning software directly from the document management platform.

Documents that are already in the user's file system may be dragged and dropped into the inbox. For example, the document may have been transferred securely from another source not integrated with the document management system, such as the patient's electronic medical record (EMR).

Separate and apart from the actions of the MD/MDC, the FDC may also upload documents to its inbox on the server using the same fax, scan and drag and drop steps described above, in step 315. Further actions of the FDC are described below beginning with step 316.

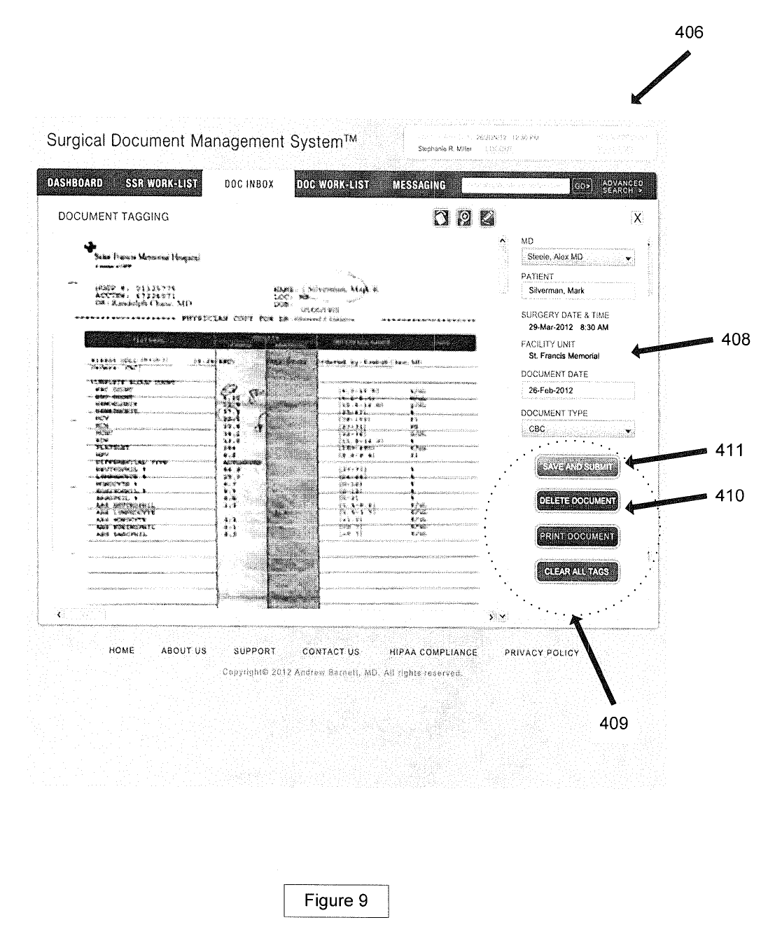

In step 304, the MD/MDC opens the document inbox and reviews each document contained therein, one at a time. Each of the documents in the inbox is tagged with the identity of the MD. The documents can be searched or filtered in the inbox by the MD/MDC using widget 404 to limit the documents to: (1) all documents; (2) untagged documents; (3) submitted documents—pending approval; and (4) submitted documents—rejected. The MD selects a document for review by double-clicking on the thumbnail of the document in the inbox, and the actual document then appears in a pop-up window 406, as shown in FIG. 9, over the inbox. The pop-up window 406 includes the selected document, as well as a sidebar 408, which includes basic information fields for the document as well as control buttons 409.

In step 306, the MD determines whether or not the document is acceptable as is. If not, then the MD deletes the document in step 308 by pressing the DELETE DOCUMENT button 410, and the process ends for this document in step 310.

If the document is acceptable in step 306, then in step 312, the MD proceeds to tag the document in pop-up window 406 with appropriate relevant information such as Patient Name, Document Date, and Document Type, using fields shown in sidebar 408. Using intelligence built into the database, selecting a Patient in the Patient field will automatically populate the correct surgery Date and Time, and correct Facility in the appropriate fields.

A variety of document manipulation tools may be provided to help tag the document. For example, viewing tools may be provided to rotate or pan/zoom the document. Markup tools may be provided to (1) highlight sections of the document, (2) circle sections of the document, (3) draw arrows linked to comments, (4) store markups separately from the document, (5) distinguish markups with colors—for example, green for the FDC and yellow for the MD/MDC, (6) distinguish prior markups, and (7) print the document with or without the markups. Note that the document will always be printed without markups before the surgery.

After the MD/MDC has tagged all fields of a document, the SAVE & SUBMIT button 411 is pressed, and the document is moved out of the MD Inbox and into the FDC Inbox in steps 314 and 316.

Fields in a document may be configured to be tagged automatically when third party vendors make their application HL7 compatible (Health Level Seven—an International standards group for health-related information). Further, the document maybe tagged to include other coded information, like the patient name, document type and document creation date.

In step 316, the FDC reviews a document in the FDC inbox. Just as with the MD inbox, the documents appears as thumbnails in window 500 in the FDC inbox, as shown in FIG. 10. The FDC user may conduct a “quick search” for documents by using the search button 504, and entering the MD, the patient, the upload date or the surgery date in field 502. The user may also conduct an advanced search using the context sensitive “advanced search” link using button 506. Further, the advanced search offers the option to enter values in the fields for MD, patient, upload date or surgery date.

In step 318, the FDC processes documents in the FDC document inbox by examining the tags. A document that remains in the FDC document inbox for more than a predefined number of days without being fully tagged with be automatically rejected. In step 320, the FDC determines whether all tags on the document are correct. If so, then in step 322, the document is accepted by the FDC. If all tags are not correct in step 320, then the document is rejected by the FDC.

Additional details of the processing step 318 are illustrated in FIG. 7B. The question of whether the six required categories are correctly tagged is checked in a sequential fashion starting with step 350. Upon examining the document to determine the data to be filled into the fields, the FDC must first determine the MD attached to the underlying SSR by looking for the MD name on the document in step 354. If the FDC is not able to identify the MD name on the document, the FDC must then determine in step 356 if the MD is nonetheless known from other sources such as a secure message. If not, then the document is rejected. Alternatively, the FDC confirms the tagged MD name in step 358. If all field tags have been approved, then the document is accepted by the FDC in step 322. If all field tags have not been approved, then the document is rejected by the FDC in step 324.

Step 360 evaluates whether the patient is in the document management database. If not, then the document is rejected in step 324. If so, then the patient name is tagged on the document in step 362.

Step 364 evaluates whether the surgery data for this patient is in the document management database. If not, then the document is rejected in step 324. If so, then the surgery date is tagged on the document in step 368.

Step 370 evaluates whether the Facility unit name is in the SDMS database, tied to the Patient and surgery date and time. If not, then the document is rejected in step 324. If it is, then the facility unit is tagged in step 372.

Step 374 evaluates whether the document date is visible on the document. If not, then the document is rejected in step 324. If so, then the document date is tagged on the document in step 376.

Step 378 evaluates whether the document type is clear from the document. If not, then the document is rejected in step 324. If so, then the document type is tagged on the document in step 380. At this point, all fields have been tagged on the document, and approved in step 352, and the FDC accepts the document in step 322.

Each of these tagging steps takes place in a pop-up window (not shown) over the FDC document inbox. This window differs from that of the MD document inbox pop-up window in that the FDC window allows the FDC to accept or reject the document.

Returning to FIG. 7A, when the document is approved by the FDC in step 322, then it is filed in the patient's e-chart in step 323, as shown in FIG. 7B, and then moved to the FDC work-list in step 325. In step 327, a hard copy of the patient chart is printed out and placed in the patient's paper chart. When the surgery date has passed, that is, the date today is greater than the scheduled surgery date, then the document is removed from the FDC work-list in step 329. In accord with a requirement of HIPAA, the document is deleted from the document management database a set number of days after the scheduled surgery date in step 331.

When the document has been rejected in step 324, a secure message is sent to the MD in step 333 with the reason for rejecting the document. In step 335, the document is moved back to the MD document inbox. In one embodiment, the document now has a red background on top of the upload date stamp to indicate that the document has been rejected.

In one embodiment, the document management system employs intelligence to automatically reject documents that are at odds with the parameters set by the surgical facility. This automatic rejection occurs after the MD submits a document, but before the submitted document appears in the FDC document Inbox.

Table III below is one example of a standard list of reasons why the document might be rejected. These parameters can be configured by the Surgical facility.

TABLE III

| Document | Condition |
|---|---|
| Insurance | Expired |
| CBC | Doc Date < Surgery Date − 14 days |
| Chest X-Ray | Doc Date < Surgery Date − 365 days |
| EKG | Doc Date < Surgery Date − 365 days |
| | and Patient Age >=50 |
| History & | Doc Date < Surgery Date − 30 days |
| Physical | |

When the scheduled surgery date of an approved SSR request is changed, it must be re-approved by the FSC and confirmed by the MD. Further, all the documents tied to the SSR will automatically go through a re-approval process as well. In particular, if the surgery is postponed, some of all of the documents may not meet the date criteria in Table III, and in that case, a previously approved document may now be rejected.

The document management system can also store multiple documents of the same type for a single surgery. For example, there may be two CBC documents having different dates, but both useful since the MD can analyze changes in the CBC document over time. Further, if multiple surgeries are scheduled for the same patient, then the document management system can share the documents among the multiple SSR requests.

FIG. 11 shows an example the FDC document work-list. As with other screens, the FDC may conduct a “quick search” for documents using the search button by entering the MD, the patient, the upload date or the surgery date. The FDC may also conduct an advanced search using the “advanced search” button, which generates a popup window with context sensitive options. For example, the advanced search offers the option to enter values in the fields for MD, patient, surgery date, pre-op visit date or case number. One example of the advanced search screen is illustrated in FIG. 12. In addition, the FDC may select a filter to limit the list to show (1) all surgeries, (2) confirmed surgeries with complete document sets, or (3) confirmed surgeries with incomplete document sets, which in this example is also located in the Advance Search popup shown in FIG. 12.

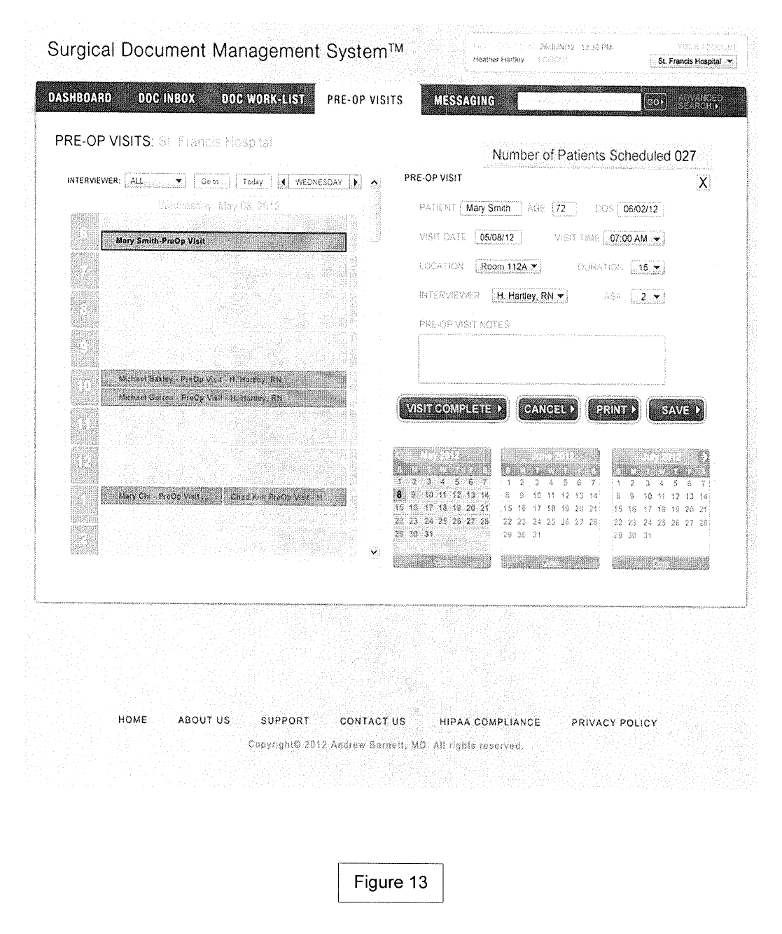

The FDC uses its document work-list to accomplish specific tasks, such as: (1) managing the pre-op visit schedule (see FIG. 13), (2) approving imaging documents/certificates (e.g., chest x-ray, CT scan, MRI, ultrasound, etc.), (3) viewing miscellaneous tracked documents, (4) viewing miscellaneous not tracked documents, (5) editing tags on approved documents, (6) rejecting a document that has been previously approved, (7) printing documents or document sets for one or more surgeries, and (8) altering the list of required documents for a specific surgery.

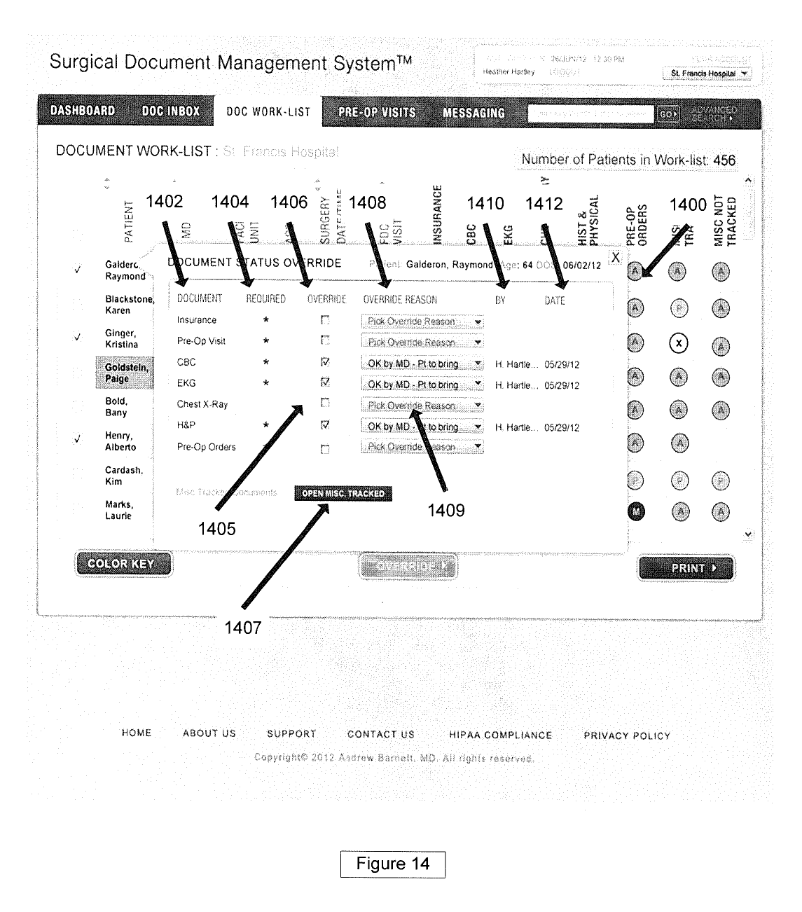

FIG. 14 shows an example pop-up window 1400 for entering over-rides to a document status. The screen includes multiple rows, with one document per row, and a number of columns of information regarding the document in that row. For example, the first column 1402 identifies a single document in each row; the second column 1404 is an indicator as to whether that document is required; and the third column 1406 includes a check box 1405 that will be selected (marked) by the FDC when it is desired to over-ride the requirement for a particular document.

The fourth column 1408 includes a pull-down menu 1409 for the FDC to select or enter a reason for the over-ride. Alternatively, the FDC can also enter a unique override reason by typing in the supplied free text field. The fifth column 1410 automatically populates with the logged in name of the FDC user, and the sixth column 1412 automatically populates with the date the over-ride was entered. Button 1407 opens a similar popup window (not shown) which lists the Miscellaneous Tracked Documents.

The document work-list for the MD is virtually the same as the work-list for the FDC, except that an MD sees multiple surgical facilities with one MD while the FDC sees one surgical facility with multiple MD's. There are also differences between what the MD/MDC can do and what the FDC can do from the document work-list. For example, only the FDC can (1) reject a document that has been previously approved, (2) deem a document set complete even if it is really not complete (by over-riding a document requirement), and (3) create or edit a pre-op visit schedule. The MD/MDC is not allowed to edit the tags of an approved document. In order to edit tags, the document will have to be deleted, then uploaded again, tagged again (with edited tags), and re-submitted for approval.

The document management system will maintain an audit trail to also keep track of who uploaded, tagged, approved, viewed, rejected, overrode, etc., every document for an SSR request. The audit trail also tracks who approved the imaging certificates, and who created or changed pre-op visits.

6. Secure Messaging

Protected Health Information (PHI) must be transmitted securely in accord with health industry regulations as dictated by HIPAA and ISO/IEC 17799, for example. The document management system thus uses secure messaging systems for user communication related to PHI, and such techniques are generally well-known and need not be specifically detailed herein. Every secure message must be related to an SSR document or to the SSR itself and must include a link to the underlying document or SSR.

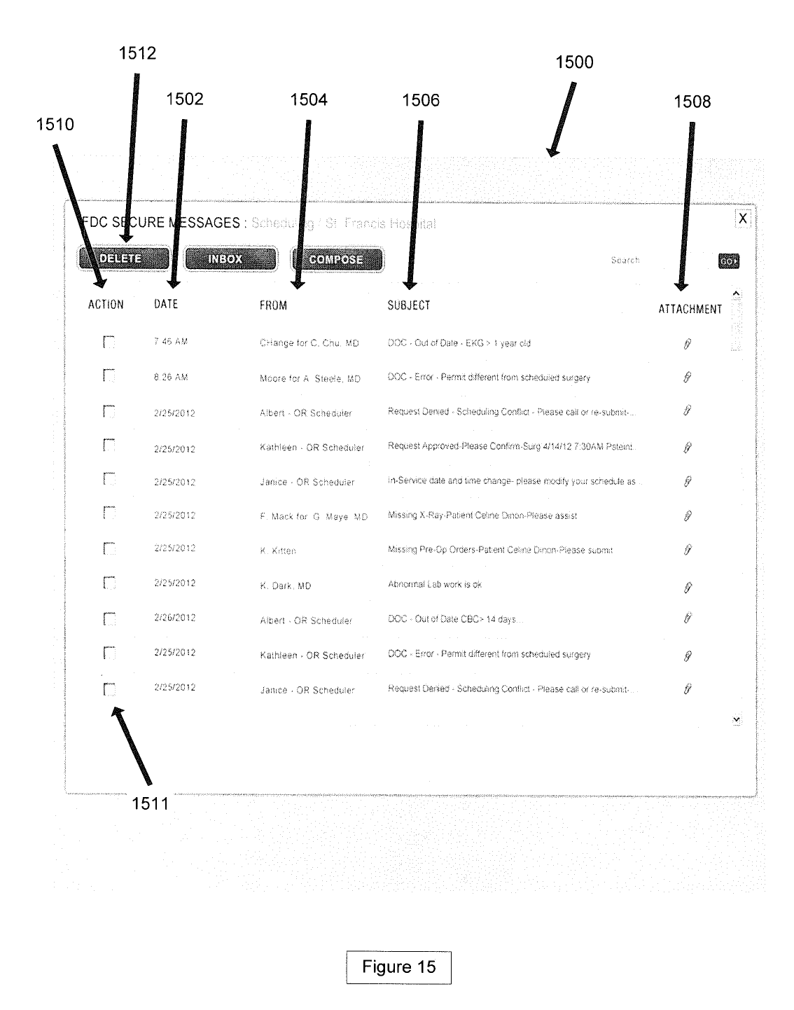

An example of a secure messaging inbox 1500 is shown in FIG. 15. The inbox 1500, in typical manner, has a DATE column 1502 for the date of the message, a FROM column 1504 indicating who sent the message, a SUBJECT column 1506 for identifying the subject of the message, and an ATTACHMENT column 1508 for indicating that there is an attachment to the message, and allowing the user to open the attached document by clicking on the attachment icon. Column 1510 is an ACTION column having check boxes 1511. Clicking on a check box 1511 selects that row for an action, such as deleting the message using the DELETE button 1512. The secure messaging window also has a search field allowing the user to search for messages or underlying document attachments based on search terms.

7. Non-Secure Messaging and Dashboards

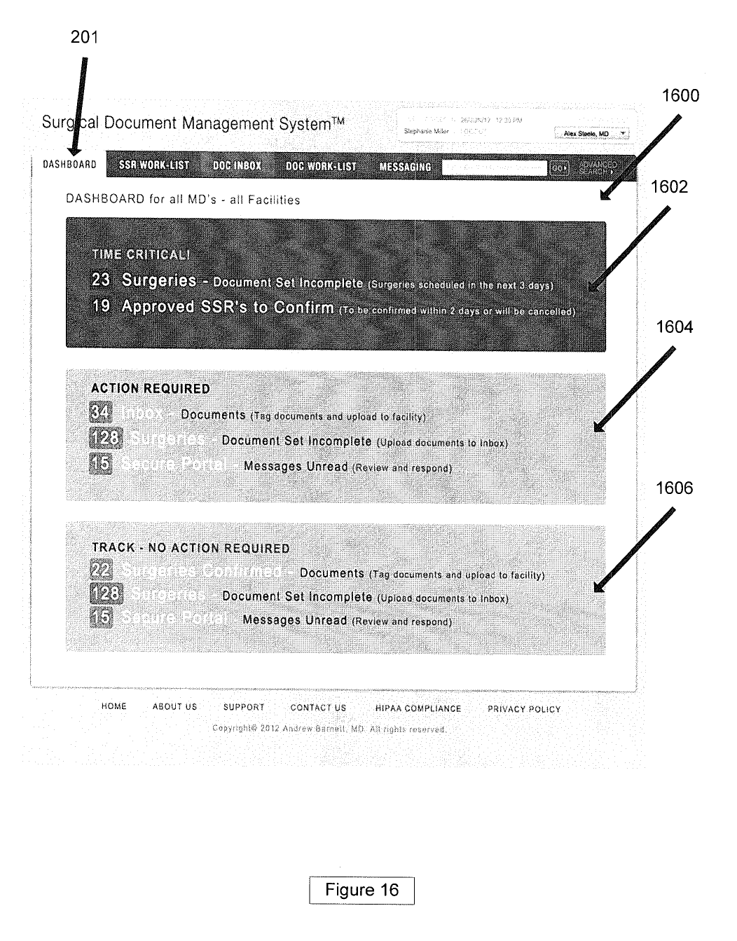

The document management system is also configured to send a “dashboard” to each user at the user's non-secure email address. A dashboard is a well-known visual user interface that provides (typically) a summary of relevant data metrics to the user. One example of a dashboard 1600 is shown in FIG. 16, which is a dashboard for MD's showing all facilities. Each non-secure email message includes at least one dashboard image which does not contain any protected health information. Further, each email will also contain a link to login to document management system.

For example, in FIG. 16, the dashboard has three large banner fields with data in each field. Field 1602 is the top-most field and lists time critical items that need attention, including scheduled surgeries within the next three days that have incomplete document sets, and approved SSRs awaiting confirmation by the MD and subject to cancellation within two days if not confirmed. Field 1604 is the middle field in FIG. 16 and lists items where non-critical action is required. For example, field 1604 shows that there are 34 items in the user's non-secure inbox, representing documents that need to be tagged and uploaded to the document management system, as well as 128 scheduled surgeries where the document set is not complete, and 15 secure unread messages in the secure mailbox. Field 1606 is the bottom-most field in dashboard 1600 and lists tracking items where no action is immediately required. Thus, field 1604 shows that 22 surgeries are confirmed, but that documents related to those surgeries still need to be tagged and uploaded to the database. Also, 128 surgeries are approved and scheduled, but have incomplete document sets. Finally, there are 15 unread messages in the secure messaging portal.

The FDC receives a dashboard similar to that of the MD in FIG. 16, but based on information from all the Facility Units with which that FDC is permitted, including documents secure messages. The FSC receives a similar dashboard, based on information from all Facility Units with which the FSC is permitted, including SSRs and secure messages.

8. Reports

The document management system can generate a number of different report types. For example, the inboxes and work-lists described above are process-based e-reports which could also be printed to hard copy or modified using filters and sort options.

The audit trail is printable or viewable on screen and presents a clear picture of how an SSR and document changed status, who did it, and when.

The document management system can also generate analysis and data mining reports. The database stores large amounts of valuable information that may be used for a multitude of purposes, and which may be manipulated to provide relevant information to stakeholders. Some examples include: (1) How long does it take to get all the documents together for a specific surgery? (2) What percentage of SSRs confirmed by the MD are subsequently cancelled, and are there certain MD's notorious for cancelling? and (3) What recommendations can be made as to how to use the Operating Rooms more efficiently.

Patient documents such as e-Charts are typically configured by the document management system to be printed a set number of days before the scheduled surgery.

Lastly, the SSR summary screen or the detail screen that contains all the SSR data can be printed by any of the users of the document management system, including MD, MDC, FSC or FDC.

9. Software Validation

The surgical document management system is a software-as-a-service (“SaaS”) enterprise application and may be easily and quickly scaled to handle thousands of surgical facilities. Because the software handles protected health information, it is required to be HIPAA compliant in all the following areas: (1) Access control (how to login); (2) Audit control (audit trails, with strict monitoring of security events such as failed login attempts, successful logins, logouts, data modifications, etc. Audit trail reports are also available for inactive or deleted users); (3) Person or entity authentication (who logs in); (4) User permission level—a user can only access specific features of the system based on their role and permission level; (5) Transmission security (e.g. SSL, HTTPS, SSH, Secured or Encrypted E-mail, etc.)—protected health information is always transferred securely with a proscribed encryption methodology used for every function to every client, including all types of communications, such as client-server and server-server (how do servers authenticate), etc.; (6) Patient document PDFs, Tiffs and databases that store patient data are encrypted to protect the system against a hacker; (7) Device and media controls (data storage, backup and delete); and (8) Audit compliance allows both current and archived data to be transferred to mobile storage devices such as DVDs or portable hard-disk.

Generally accepted software development standards require that all software be tested as part of the development cycle. Internal or external auditors, assessing the quality and effectiveness of software, generally require documentation of test results as part of the auditing process, referred to as software development validation documents. Following the generally accepted software development standards, the software development validation documents include the following four categories: Design Specifications, Test Protocols, Test Results, and Test Reports. Validation documents are typically generated manually through quality assurance protocols. For example, software developers may use a test-driven development (“TDD”) process to first write a failing test case, then produce code to pass that test. However, since most software applications change many times during the software development cycle, keeping the latest version of these document types is very time consuming, labor intensive, and expensive. Therefore, validation documents are usually generated at the end of a development cycle.

It would be desirable to automatically generate software development validation documents, thereby saving a tremendous amount of time, and encouraging documentation and validation throughout the software development cycle. The continuous generation of documents which validate the testing process leads to increased efficiency, accuracy, and ultimately better software.

In one embodiment, a behavior-driven development framework is used to automatically create easily understandable validation documents. For example, the description for each program feature may be written in a natural language that non-programmers can read, such as Gherkin. The feature description is then parsed using a Gherkin parser. The feature description is parsed by Gherkin and a formatter developed using the Ruby programming language is passed to a Cucumber program as a parameter to generate the Design Specifications, Test Protocols, Test Results, and Test Reports. Thus, the validation documentation is automatically produced from the feature specification file and is more easily understood by non-programmer auditors who are responsible for making HIPAA audits of software.

As noted, the feature description is written by hand using Gherkin syntax to set out the requirements for that program feature. For example, Appendix A shows a feature description written using Gherkin to specify the FDC inbox feature, described above. The term “scenario” is a special term that indicates that specific features are defined in the expressions following that term. Thus, there are three scenarios written in Appendix A: the FDC inbox screen; the Number of Documents in the FDC inbox; and a Table that shows the documents. These scenarios describe how the user interface will look when the FDC inbox is selected. The first scenario describes how the FDC inbox looks when active. The second scenario describes presenting the number of documents in the inbox. The third scenario describes a table for presenting documents in the FDC inbox.

The term “@wip” (work-in-progress) is also a special term which indicates that the expression that follows is related to the scenario above, i.e., can be used to make a calculation or otherwise take action through the program expression. For example, the first @wip tag defines a sort routine based on the column header, while the second @wip tag defines a reverse sort routine based on the column header.

The feature specification in Appendix A is parsed to produce the Design Specification shown in Appendix B, which looks very similar to the original file. The Design Specification is simply a list of the features and functionality in the software, and must include sufficient detail to allow writing positive and negative test cases. Further, the Design Specification is readily understandable by non-programmers since it originates from the natural language Gherkin syntax.

The Feature Description in Appendix A is also parsed in order to create a Test Protocol for each of the scenarios/specifications listed in the Design Specification, as listed in Appendix C. For example, Specification S1.1 correlates with Test T1.1; Specification S1.2 correlates with Test T1.2, and so on.

The Test Protocol, the Test Results and the Test Report are also generated from the Feature Description. The Test Protocol is executed in order to generate Test Results. Appendix D shows the results of the execution of the Test Protocol, with each result being correlated to a specific Test Protocol. Finally, the Test Results of Appendix D are summarized into a Test Report, as shown in Appendix E. The Test Report is a simple listing showing whether the test result was a pass, a fail or remains pending.

Each of these steps can be performed by a processor system and integrated with the surgical document management system in order to regularly and continuously update the validation documentation. Further, although the surgical document management system requires secure messaging for personal health information, other applications having non-secure data requirements may also benefit from software validation using this technique.

These and other changes can be made to the present systems, methods and applications in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

1. A method for managing the scheduling of a surgery and the documents specified for the surgery, comprising:
at a server, receiving a request from a first client computer to reschedule a previously scheduled surgery;
forwarding the request from the server to a second client computer;
at the server, receiving an approval or a rejection from the second client computer of the request to reschedule; and
if the rescheduling request is approved:
at the server, generating a list of a plurality of documents specified for the scheduled surgery;
at the server, receiving the plurality of documents specified on the list;
storing the plurality of documents in a data store accessible to the server;
at the server, generating an approval or a rejection of each of the plurality of documents; and
at the server, sending notice of the approval or rejection of each document from the server to the first client computer.

2. The method of claim 1, wherein the server generates an approval or rejection of each document based upon predefined criteria for each document.

3. The method of claim 1, wherein the second client computer determines whether to generate an approval or rejection of each document at the server based upon predefined criteria for each document.
sending notice of the rejection from the server to the first client computer.

4. The method of claim 1, further comprising:
at the server, receiving from the second client computer reasons for the rejection of a document; and
sending the reasons for rejection from the server to the first client computer along with the notice of rejection.

5. The method of claim 1, further comprising:
at the server, compiling a list of the plurality of documents including a status of each of the documents, wherein the list is accessible to both the first client computer and the second client computer; and
at the server, receiving input from either the first or second client computer to modify the list.

6. The method of claim 1, further comprising:
if the request to reschedule the surgery is approved, then sending from the server to the first client computer a request to confirm the rescheduled surgery.

7. The method of claim 6, further comprising:
if the first client computer fails to confirm the rescheduled surgery, then cancelling the surgery.

8. The method of claim 7, further comprising:
if the first client computer fails to confirm the rescheduled surgery within a first preset number of days after receiving approval, then sending a second request to confirm the rescheduled surgery; and
if the first client computer fails to respond to the second request and confirm the rescheduled surgery within a second preset number of days after the second request is sent, then cancelling the surgery.

9. The method of claim 1, further comprising:
at the server, receiving from the first client computer input in the form of tags applied to each of the plurality of documents.

10. The method of claim 1, further comprising:
at the server, automatically generating software validation documents using a behavior-driven development tool.

11. A non-transitory computer-readable storage medium encoded with executable instructions for managing the scheduling of a surgery and the documents specified for the surgery, the instructions comprising:
at a server, receiving a request from a first client computer to reschedule a previously scheduled surgery;
forwarding the request from the server to a second client computer;
at the server, receiving an approval or a rejection from the second client computer of the request to reschedule; and
if the rescheduling request is approved:
at the server, generating a list of a plurality of documents specified for the scheduled surgery;
at the server, receiving the plurality of documents specified on the list;
storing the plurality of documents in a data store accessible to the server;
at the server, generating an approval or a rejection of each of the plurality of documents; and
at the server, sending notice of the approval or rejection of each document from the server to the first client computer.

12. The computer-readable storage medium of claim 11, the instructions further comprising:
the server generating an approval or rejection of each document based upon predefined criteria for each document.

13. The computer-readable storage medium of claim 11, the instructions further comprising:
the second client computer determining whether to generate an approval or rejection of each document at the server based upon predefined criteria for each document.

14. The computer-readable storage medium of claim 11, the instructions further comprising:
at the server, receiving from the second client computer reasons for the rejection of a document; and
sending the reasons for rejection from the server to the first client computer along with the notice of rejection.

15. The computer-readable storage medium of claim 11, the instructions further comprising:
at the server, compiling a list of the plurality of documents including a status of each of the documents, wherein the list is accessible to both the first client computer and the second client computer; and
at the server, receiving input from either the first or second client computer to modify the list.

16. The computer-readable storage medium of claim 11, the instructions further comprising:
if the request to reschedule the surgery is approved, then sending from the server to the first client computer a request to confirm the rescheduled surgery.

17. The computer-readable storage medium of claim 16, the instructions further comprising:
if the first client computer fails to confirm the rescheduled surgery, then cancelling the surgery.

18. The computer-readable storage medium of claim 17, the instructions further comprising:
if the first client computer fails to confirm the rescheduled surgery within a first preset number of days after receiving approval, then sending a second request to confirm the rescheduled surgery; and
if the first client computer fails to respond to the second request and confirm the rescheduled surgery within a second preset number of days after the second request is sent, then cancelling the surgery.

19. The computer-readable storage medium of claim 1, the instructions further comprising:
at the server, receiving from the first client computer input in the form of tags applied to each of the plurality of documents.

20. A medical document management system, comprising:
a data store accessible to a server for storing a plurality of documents;
a processor programmed with instructions to perform the following steps:
at the server, receiving a request from a first client computer to reschedule a previously scheduled surgery;
forwarding the request from the server to a second client computer;
at the server, receiving an approval or a rejection from the second client computer of the request to reschedule; and
if the rescheduling request is approved:
at the server, generating a list of a plurality of documents specified for the scheduled surgery;
at the server, receiving the plurality of documents specified on the list;
storing the plurality of documents in a data store accessible to the server;
at the server, generating an approval or a rejection of each of the plurality of documents; and
at the server, sending notice of the approval or rejection of each document from the server to the first client computer.
